(19) United States
(12) Patent Application Publication
(10) Pub. No.: US 2007/0067341 A1
(43) Pub. Date: Mar. 22, 2007

(54) Automated user interface functional requirements tool

(75) Inventors: Jiangfeng Chen, Herndon, VA (US); Mary Colella Kumar, Washington, DC (US); Matthew Lewis Nuss, Herndon, VA (US); Kenneth R. Shrader, Basye, VA (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/230,805

(22) Filed: Sep. 20, 2005

(51) Int. Cl. G06F 17/00

(52) U.S. Cl. 707/104.1

(57) ABSTRACT

A system and method for generating user interface specifications. A system is disclosed that includes a component database for storing sets of module data, wherein each set of module data describes a set of requirements for implementing a user interface activity; a module management system for managing the module data; and a system for generating a user interface specification based on a selected set of module data.

### BACKGROUND OF THE INVENTION

1. Technical Field

The present invention relates generally to defining user interface functional requirements for software tools, and more specifically relates to an automated system and method for generating functional specification documents.

2. Related Art

In developing software applications that provide substantial user interaction, the development of the user interface and the associated functional requirements is a critical component. For instance, in a Web application, there may be numerous pages where an end user must input data, which in turn drives the behavior of the application. Accordingly, when developing such applications, a set of user interface functional requirements must be created to define all of the associated user-specific inputs, functions, outputs and behaviors. User interface functional requirements include, e.g., Graphical User Interface (GUI) functional templates, detailed user interface work products, specifications and supporting documentation.

A detailed specification for each user interface activity usually requires substantial documentation, often across several different documents and file formats, with input from numerous team members. Detailed functional specifications are often created in templates using, e.g., Microsoft WORD™. If visual representations are to be provided, they must first be created in another software application (such as VISIO™), and then cut and pasted into the Word document to obtain a complete specification. When modifications to an element of an activity are made (e.g., a new field is added), updates must be manually input for all instances of the element across various documents and file formats.

Often, aggressive production schedules with shifting deadlines and requirements make the quick and accurate generation of flexible user interface functional requirements a key production issue to maintain project schedule and client satisfaction. Updating the specification is often labor-intensive, especially on tight deadlines. Moreover, transposing updates across multiple documents and file formats is prone to causing mistakes. In addition, the recent trend toward object-oriented design and documentation does not allow for graphical representation of elements or compiled user interface modules.

Existing tools focus on an architecture model that automates the integration of the architecture model and implementation of code, such as IBM Rational's XDE™, ROSE™ development software, and Borland's TOGETHERSOFT™. Unfortunately, these tools are modeling applications and do not define component or page level details. Moreover, they do not allow for specific approaches to a solution or component, and cannot automatically update changes to a functional specification and related inputs at the project level.

Accordingly, a need exists for a user interface functional requirements tool that can automatically generate user interface specifications, including functional requirements, Web page templates and actual code to implement the user interface.

### SUMMARY OF THE INVENTION

The present invention addresses the above-mentioned problems, as well as others, by providing a system and method that can automatically generate user interface specifications, including functional specifications, Web page templates and actual code to implement the user interface. The invention thus allows a development team to quickly and accurately generate detailed user interface work products and supporting documentation using a single comprehensive approach.

In a first aspect, the invention provides a system for generating user interface specifications, comprising: a component database for storing sets of module data, wherein each set of module data describes a set of requirements for implementing a user interface activity; a module management system for managing the module data; and a system for generating a user interface specification based on a selected set of module data.

In a second aspect, the invention provides a computer program product stored on a computer usable medium for generating a user interface specification, comprising: program code configured for accessing and managing sets of module data stored in a component database, wherein each set of module data describes a set of requirements for implementing a user interface activity; and program code configured for generating a user interface specification based on a selected set of module data.

In a third aspect, the invention provides a computerized method for generating a user interface specification, comprising: providing a component database for storing sets of module data, wherein each set of module data describes a set of requirements for implementing a user interface activity; associating a user interface activity with a selected set of module data; and generating a user interface specification for the user interface activity based on the selected set of module data.

In a fourth aspect, the invention provides a method for deploying an application that allows users to generate a user interface specification, comprising: providing a computer infrastructure being operable to: provide access to a component database having sets of module data, wherein each set of module data describes a set of requirements for implementing a user interface activity; associate a user interface activity with a selected set of module data; and generate a user interface specification for the user interface activity based on the selected set of module data.

In a fifth aspect, the invention provides computer software embodied in a propagated signal for implementing a system for generating a user interface specification, the computer software comprising instructions to cause a computer to perform the following functions: access and manage sets of module data stored in a component database, wherein each set of module data describes a set of requirements for implementing a user interface activity; and generate a user interface specification based on a selected set of module data.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a user interface function requirements (UIFR) system in accordance with an embodiment of the present invention.

FIG. 2 depicts a computer system having a user interface function requirements (UIFR) system in accordance with an embodiment of the present invention.

FIG. 3 depicts a first illustrative GUI screenshot for a module management system in accordance with an embodiment of the present invention.

FIG. 4 depicts a second illustrative GUI screenshot for a module management system in accordance with an embodiment of the present invention.

FIG. 5 depicts an example of a functional specification generated by a user interface function requirements (UIFR) system in accordance with an embodiment of the present invention.

### DETAILED DESCRIPTION OF THE INVENTION

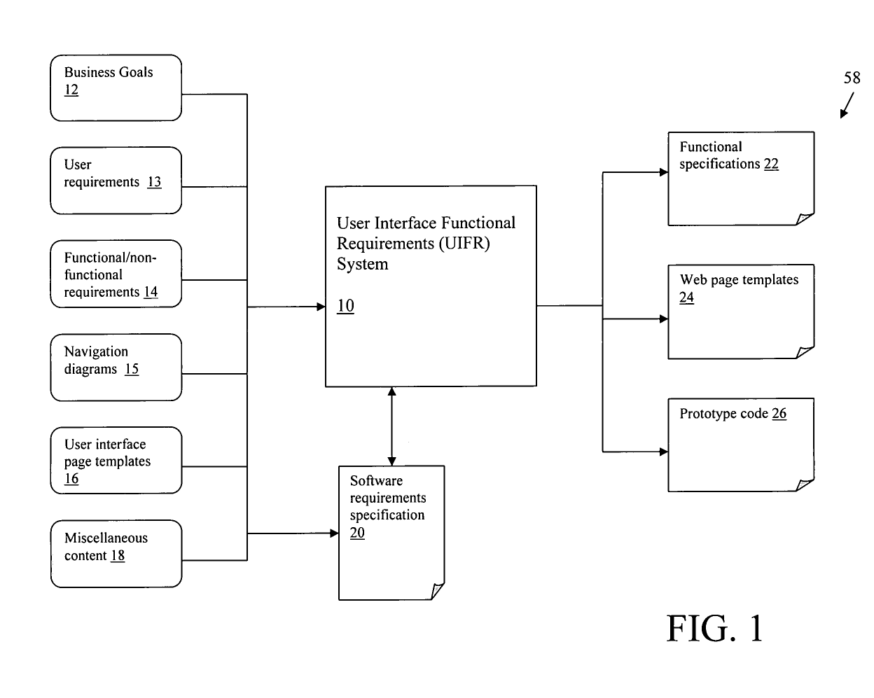

Referring now to drawings, FIG. 1 depicts a user interface function requirements (UIFR) system 10 in accordance with an embodiment of the present invention. It is understood that while the embodiments detailed herein generally relate to Web application development, it is understood that the invention could be utilized in any software application development environment. UIFR system 10 provides an automated mechanism through which user interface developers can enter/select inputs typical of a user interface development process and automatically generate user interface specifications 58.

In the illustrative embodiment shown in FIG. 1, typical inputs include: (1) business goals 12, namely, what type of application is required, e.g., a retail portal, a government Web site, an association portal, etc.; (2) user requirements 13; (3) functional/non-functional requirements 14, including use cases, user scenarios, interface specifications, etc.; (4) navigation diagrams 15, i.e., how does the user interface process flow throughout the application; (5) user interface page templates 16, i.e., “wireframes” that show what an interface should look like; and (6) other miscellaneous content 18, including validation/business rules catalogs, message catalogs, common vocabulary and glossary, general page content, etc.

Based on those inputs, UIFR system 10 can automatically generate user interface (UI) specifications 58 that include, e.g., functional specifications 22, Web page templates 24, and application prototype code 26. Because the process is automated, UIFR system 10 allows for quick and accurate updates to the user interface specifications 58. In particular, UIFR system 10 can store all relevant user interface specifications 58 in one location, eliminate errors due to transcribing across documents, allow for automated updates across all instances of a specification, reference ancillary data to expand the specification's use across project teams, and generate functioning code, e.g., as proof-of-concept demonstrations.

Note that the inputs described above also traditionally are used to create what is commonly referred to as a software requirements specification 20. The software requirements specification 20 is typically a less technical document geared toward the customer to describe their requirements. The data from this specification can also be inputted to the UIFR system 10, and updated from the UIFR system 10.

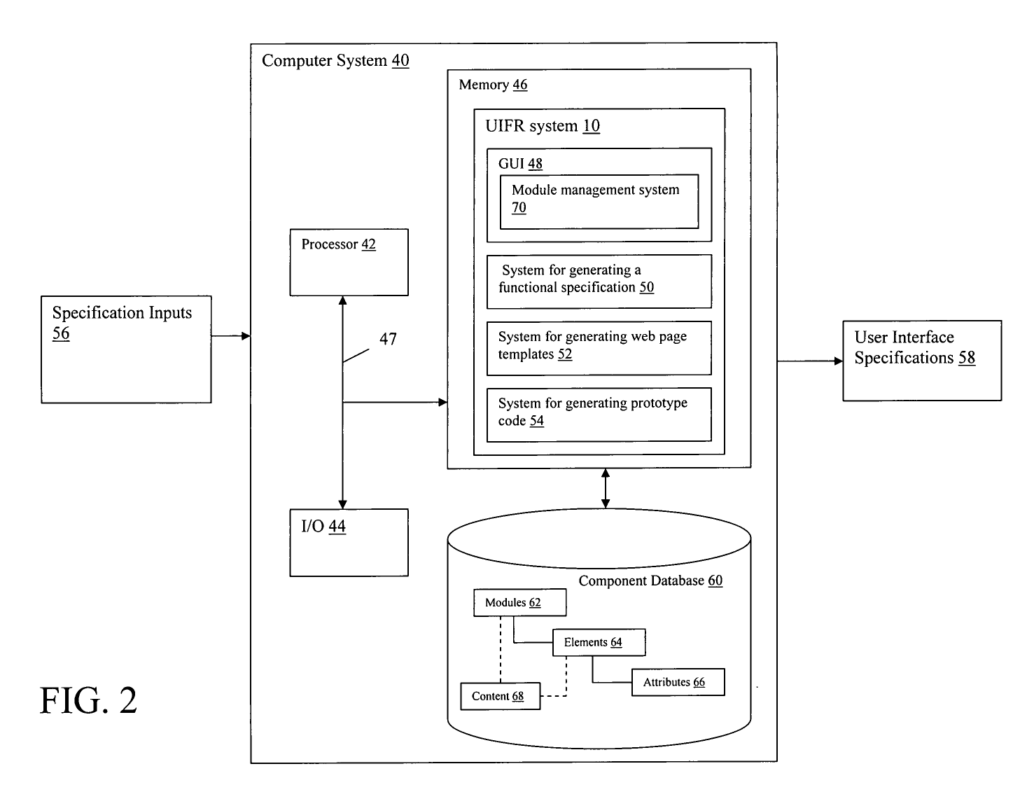

Referring now to FIG. 2, a computer system 40 is shown having a UIFR system 10 for generating user interface specifications 58 based on a specification inputs 56. UIFR system 10 includes: (1) a graphical user interface 48 having a module management system 70; (2) a system for generating functional specifications 50; (3) a system for generating web page templates 52; and (4) a system for generating prototype code 54. In addition, a component database 60 is provided for storing various user interface components. In this illustrative embodiment, UIFR system 10 and component database 60 are implemented using an object oriented data model that utilizes a clearly defined process for generating user interface specifications 58.

A typical application being developed comprises a set of distinct user interfaces, each for performing a unique “activity” (e.g., a sign-in dialog, a form for registering new users, a checkout window, a payment window, etc.). In accordance with the present invention, the functional requirements of each of these unique activities are specified using one or more modules 62. As shown, component database 60 includes an object oriented data model comprising modules 62, wherein each module 62 comprises a set of module data that includes one or more elements 64, and wherein each element 64 may include one or more attributes 66. Different activities can share the same module (e.g., name and address data could be collected for two distinct activities, but can implemented using the same module).

Illustrative elements 64, which together help form a module 62, may include, e.g., fields, drop down boxes, data, etc. Each of the elements 64 may have one or more attributes 66 including, e.g., characteristics, data type, validation requirements, an element's order in relation to the other elements, etc. In addition, content 68, such as help content, error messages, etc., may be linked directly to the module 62 or individual element 64. Each set of module data forms the basis from which a user interface specification can be generated. Because the module data is stored in a clearly defined database format, modules 62 can be quickly accessed, modified, copied, reused, etc. Any modifications to a module can be automatically carried throughout the generated user interface specifications 58 without manual intervention. Accordingly, edits to a module 62 will generate updates (traceable via version numbering) to all instances of the module across the entire application.

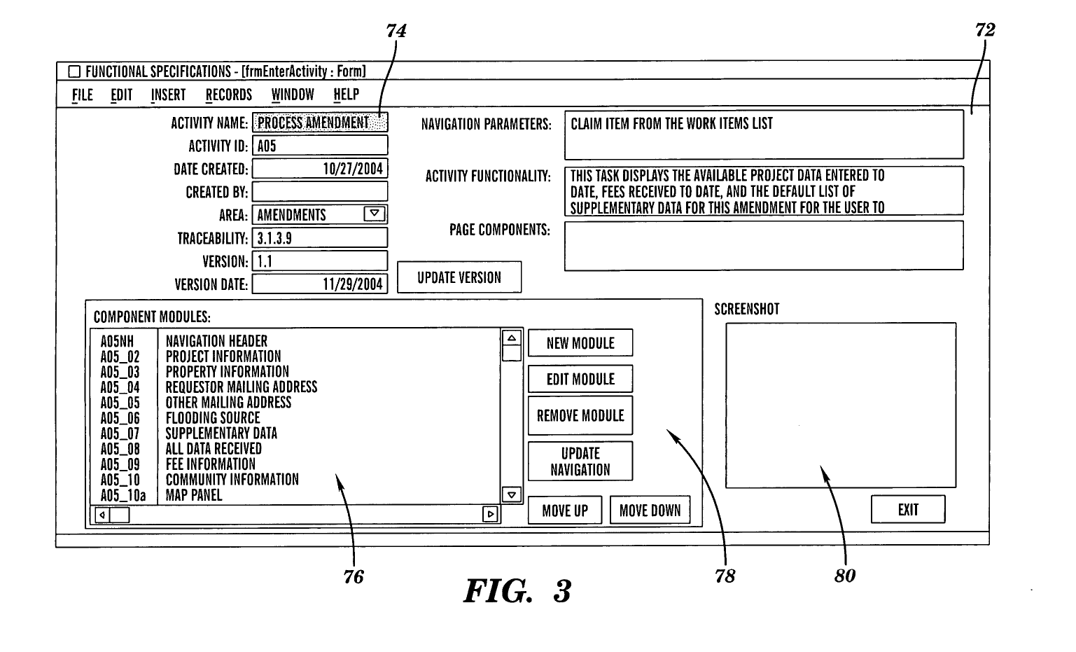

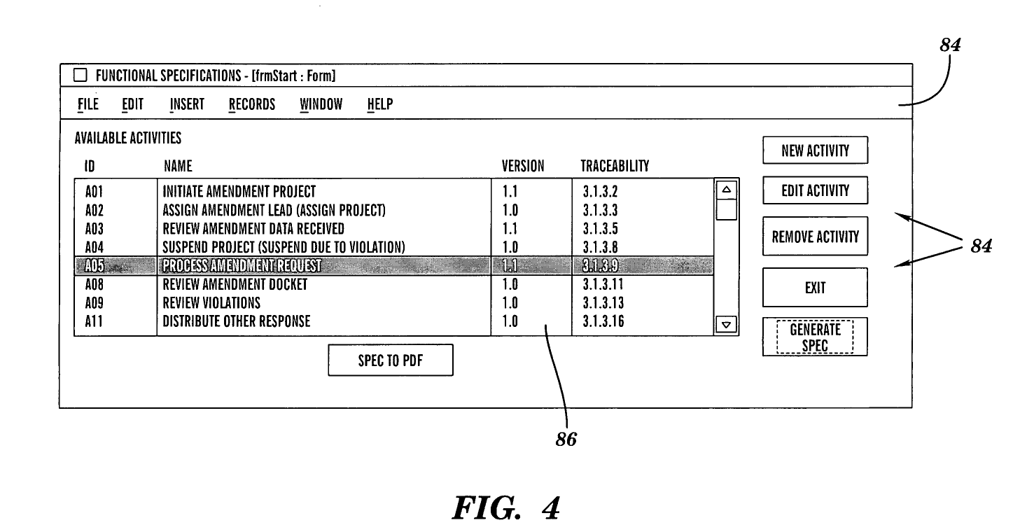

As noted, UIFR system 10 includes a GUI 48 with a module management system 70. Module management system 70 provides access to the modules 62 in component database 60. Illustrative GUIs of a module management system 70 are described below in FIGS. 3 and 4. Once a module 62 is defined/selected within the module management system 70, the user can automatically generate a user interface specification for an associated user interface activity. In this illustrative embodiment, UIFR system 10 provides systems 50, 52 and 54 for generating three different formats of a user interface specification, including a functional specification 22, a web page template 24 and prototype code 26. Each of these formats is generated directly from the module data stored in component database 60. It is understood that although not shown, other user interface specification formats could likewise be generated and fall within the scope of this invention.

Prototype code 26 may comprise any type of code or artifact, such as HTML(HyperText Markup Language), XML (extensible Markup Language), JSP (Java Server Page), etc. Such artifacts can be assembled for working proof-of-concept prototypes of the application. Further post processing could also be applied to the prototype code 26 to create actual code for the application under development. Functional specifications 22 and Web page templates 24 can also be output in any format, e.g., HTML, Microsoft Word, Adobe PDF documents, etc., for electronic and paper distribution. UIFR system 10 may also include a reporting system to generate various reports. In addition, the generated user interface specifications 58 can be configured to accommodate various requirements, i.e., they may be “branded” to meet client engagement document template requirements.

FIG. 3 depicts an illustrative GUI dialog 72 for module management system 70 that allows a user to select/edit/create/delete a module selected from a list of modules 76 for a given activity 74. In this example, the user is able to specify/search for the activity 74 by name, ID, creation date, activity area, and traceability (i.e., version). In addition, the user can enter navigation parameters, activity functionality and page components for the activity 74. At the bottom of the GUI dialog 72, the user is able to select a module from a list 76 for the activity, create a new module, edit a selected module, remove a module, and update navigation information for the module using a set of buttons 78. In addition, the user is able to cut and paste a screenshot of the intended visual representation of the module into a screenshot window 80. Accordingly, by providing a system through which a common set of modules are utilized for a software application development environment, a consistent approach for generating user interface specifications 58 is guaranteed.

FIG. 4 depicts an additional GUI dialog 84 that allows a user to select an activity 74 from a list of activities 86. Through a series of buttons 84, the user is able to create a new activity, edit an activity, remove an activity, exit, and cause a user interface specification to be generated for a given activity. As noted above, UIFR system 10 can generate HTML or other web browser-readable code directly from the module data stored in component database 60. The resulting graphical representation of the specification can then be included directly with a generated functional specification 22. Note that for complex activities, a functional specification 22 may be several pages long. Any updates to the module data by the module management system 70 will be captured with each successive code build, allowing for both up-to-date visual representation of the specification and timely demonstrations compiled directly from the specification and code.

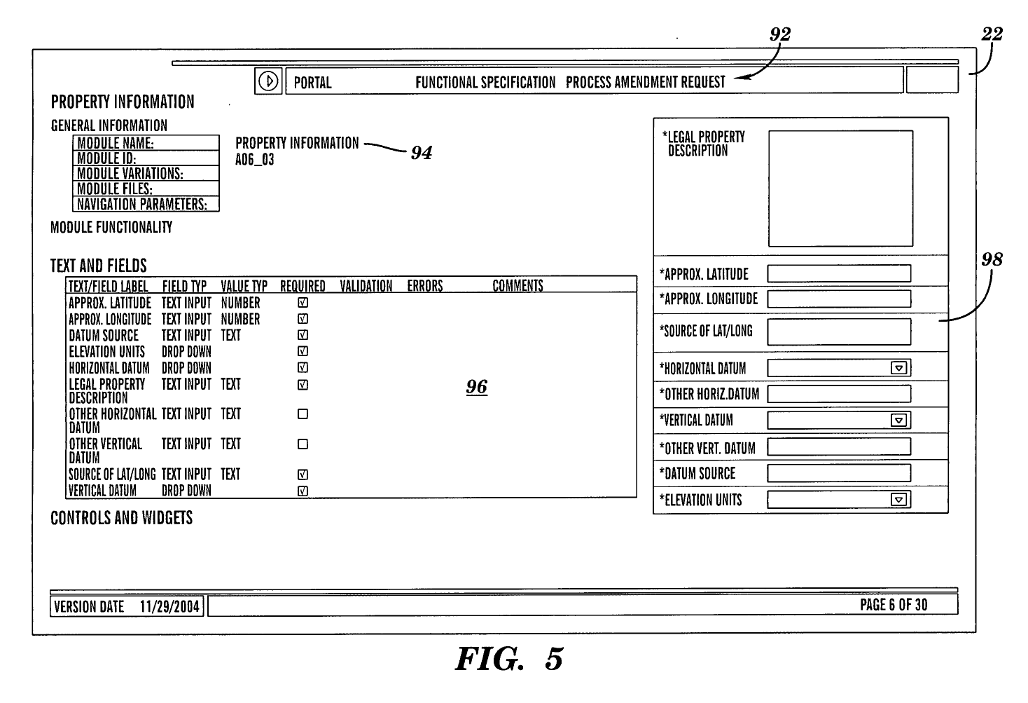

FIG. 5 depicts an example of a generated functional specification 22 for the activity selected in FIGS. 3 and 4. The functional specification 22 includes the module name 94 and related information, the set of elements 96 that make up the module, and a visual representation 98 of the activity. Note that the visual representation 98 could either be incorporated from a screenshot pasted into the module management system 70, or be dynamically generated, e.g., by a web page template generation process, as alluded to above. Additional information, such as module functionality, controls and widgets, etc., could likewise appear in the functional specification 22.

Note that the computer system 40 shown in FIG. 2 could be implemented in any fashion, and could be implemented as part of a client and/or a server. Computer system 40 generally includes a processor 42, input/output (I/O) 44, memory 46, and bus 47. The processor 42 may comprise a single processing unit, or be distributed across one or more processing units in one or more locations, e.g., on a client and server. Memory 46 may comprise any known type of data storage and/or transmission media, including magnetic media, optical media, random access memory (RAM), read-only memory (ROM), a data cache, a data object, etc. Moreover, memory 46 may reside at a single physical location, comprising one or more types of data storage, or be distributed across a plurality of physical systems in various forms.

I/O 44 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 47 provides a communication link between each of the components in the computer system 40 and likewise may comprise any known type of transmission link, including electrical, optical, wireless, etc. Although not shown, additional components, such as cache memory, communication systems, system software, etc., may be incorporated into computer system 40.

Access to computer system 40 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

Component database 60 may likewise be implemented in any fashion, e.g., as a relational database, etc. Moreover, it could reside at a single location or be distributed across a network.

Furthermore, it should be appreciated that the teachings of the present invention could be offered as a business method on a subscription or fee basis. For example, a computer system 40 comprising an UIFR system 10 could be created, maintained and/or deployed by a service provider that offers the functions described herein for customers. That is, a service provider could offer to provide an online application that generates user interface specifications 58 as described above.

It is also understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for generating user interface specifications, comprising:
a component database for storing sets of module data, wherein each set of module data describes a set of requirements for implementing a user interface activity;
a module management system for managing the module data; and
a system for generating a user interface specification based on a selected set of module data.

2. The system of claim 1, wherein each set of module data comprises a module, a set of elements for the module, and a set of attributes associated with the set of elements.

3. The system of claim 1, wherein the module management system is implemented with a graphical user interface that allows a user to associate a module with an activity.

4. The system of claim 1, wherein the module management system is implemented with a graphical user interface that allows a user to modify a selected module.

5. The system of claim 1, wherein the module management system allows a user to associate a module with a plurality of different user interface activities.

6. The system of claim 1, wherein the system for generating a user interface specification can be directed to automatically generate a functional specification.

7. The system of claim 6, wherein the functional specification comprises a visual representation of a selected activity.

8. The system of claim 1, wherein the system for generating a user interface specification can be directed to automatically generate a Web page template.

9. The system of claim 1, wherein the system for generating a user interface specification can be directed to automatically generate prototype code to implement a selected user interface activity.

10. A computer program product stored on a computer usable medium for generating a user interface specification, comprising:
program code configured for accessing and managing sets of module data stored in a component database, wherein each set of module data describes a set of requirements for implementing a user interface activity; and
program code configured for generating a user interface specification based on a selected set of module data.

11. The computer program product of claim 10, wherein each set of module data comprises a module, a set of elements for the module, and a set of attributes associated with the set of elements.

12. The computer program product of claim 10, wherein the program code configured for accessing and managing sets of module data is implemented with a graphical user interface that allows a user to associate a module with an activity.

13. The computer program product of claim 10, wherein the program code configured for accessing and managing sets of module data is implemented with a graphical user interface that allows a user to modify a selected module.

14. The computer program product of claim 10, wherein the program code configured for accessing and managing sets of module data allows a user to associate a module with a plurality of different user interface activities.

15. The computer program product of claim 10, wherein the program code configured for generating a user interface specification can be directed to automatically generate a functional specification.

16. The computer program product of claim 15, wherein the functional specification comprises a visual representation of a selected activity.

17. The computer program product of claim 10, wherein the program code configured for generating a user interface specification can be directed to automatically generate a Web page template.

18. The computer program product of claim 10, wherein the program code configured for generating a user interface specification can be directed to automatically generate prototype code to implement a selected user interface activity.

19. A computerized method for generating a user interface specification, comprising:
providing a component database for storing sets of module data, wherein each set of module data describes a set of requirements for implementing a user interface activity;
associating a user interface activity with a selected set of module data; and
generating a user interface specification for the user interface activity based on the selected set of module data.

20. The computerized method of claim 19, wherein each set of module data comprises a module, a set of elements for the module, and a set of attributes associated with the set of elements.

21. The computerized method of claim 19, wherein the step of associating a user interface activity with a selected set of module data is implemented with a graphical user interface.

22. The computerized method of claim 19, wherein the step of associating a user interface activity with a selected set of module data is implemented with a graphical user interface that allows a user to modify a selected set of module data.

23. The computerized method of claim 19, wherein the step of associating a user interface activity with a selected set of module data allows a user to associate a set of module data with a plurality of different user interface activities.

24. The computerized method of claim 19, wherein the step of generating a user interface specification automatically generates a functional specification.

25. The computerized method of claim 24, wherein the functional specification comprises a visual representation of a selected activity.

26. The computerized method of claim 19, wherein the step of generating a user interface specification automatically generates a Web page template.

27. The computerized method of claim 19, wherein the step of generating a user interface specification automatically generates prototype code to implement a selected user interface activity.

28. A method for deploying an application that allows users to generate a user interface specification, comprising:
providing a computer infrastructure being operable to:
provide access to a component database having sets of module data, wherein each set of module data describes a set of requirements for implementing a user interface activity;
associate a user interface activity with a selected set of module data; and
generate a user interface specification for the user interface activity based on the selected set of module data.

29. Computer software embodied in a propagated signal for implementing a system for generating a user interface specification, the computer software comprising instructions to cause a computer to perform the following functions:
access and manage sets of module data stored in a component database, wherein each set of module data describes a set of requirements for implementing a user interface activity; and
generate a user interface specification based on a selected set of module data.
